(19) United States
(12) Patent Application Publication
(10) Pub. No.: US 2018/0306389 A1
(43) Pub. Date: Oct. 25, 2018

(54) WIRELESS SOLAR LAMP ASSEMBLY

(71) Applicant: Ling Yung LIN, Taipei (TW)

(72) Inventor: Ling Yung LIN, Taipei (TW)

(21) Appl. No.: 15/496,495

(22) Filed: Apr. 25, 2017

(51) Int. Cl. F21L 4/08; H02S 99/00; F21V 21/096; H05B 33/08; F21V 3/00; F21V 23/00

(52) U.S. Cl. CPC F21L 4/08; H02S 99/00; F21V 23/003; H05B 33/0809; F21V 3/00; F21V 21/0965

(57) ABSTRACT

A wireless solar lamp assembly is provided, which may include a solar module with an electromagnetic wave generating unit and a lamp module with an electromagnetic wave receiving unit. The solar module and the lamp module are combined with each other via magnetic attraction, and can be easily installed and fixed on a predetermined object; therefore, the lamp assembly is an environmental-friendly and energy-saving outdoor lamp without wiring and easy to install, which is very convenient for outdoor activities.

### BACKGROUND OF THE INVENTION

### 1. Field of the Invention

The present invention generally relates to an outdoor lamp, in particular to a wireless solar lamp assembly which can be swiftly installed and removed.

### 2. Description of the Related Art

Sunshine shed (umbrella) is a frequently-used outdoor equipment, which can shield users against sunshine and rain; besides, sunshine shed is of simple structure, and can be conveniently installed and moved. Accordingly, sunshine shed is comprehensively applied to outdoor gatherings, leisure activities, and the like, or even applied to residences and stores. However, contractile sunshine shed which can be easily opened and closed is still rare.

When a user uses a sunshine shed at night or in an environment with insufficient light, the user must need proper lighting. In general, the user usually uses the sunshine shed with other lighting devices or install a lighting device on the sunshine shed by additional wiring for powering the lighting device, which is not a good way to use the sunshine shed. Accordingly, it is very inconvenient to install the lighting device or provide the wiring for powering the lighting device. Further, the wiring outside the sunshine shed may influence the traffic flow, or even result in danger, which has become an important issue to be solved for a long time. The inventor of the present invention has been engaged in research about solving the above problems for a long time and then finally provides the present invention.

### SUMMARY OF THE INVENTION

Therefore, it is a primary objective of the present invention to provide a wireless solar lamp assembly, which adopts solar energy and magnetic attraction positioning, and uses wireless electromagnetic wave to transmit electrical energy so as to provide an environmental-friendly and energy-saving outdoor lamp without wiring and easy to install. The wireless solar lamp assembly can effectively improve the shortcomings of prior art and can be more convenient in use.

To achieve the foregoing objective, the present invention provides a wireless solar lamp assembly, which mainly includes a solar module and a lamp module. The solar module includes a light receiving surface and an installation surface; the light receiving surface includes a solar energy conversion unit capable of receiving and converting light into electrical energy, and the installation surface includes at least one first magnetic positioning element. The lamp module includes a lamp holder with a light source. The bottom of the lamp holder includes at least one second magnetic positioning element corresponding to the first magnetic positioning element, and the second magnetic positioning element is magnetically connected to the first magnetic positioning element, whereby the lamp module and the solar module can be respectively installed on both sides of a predetermined object. More specifically, the solar module and the lamp module respectively include an electromagnetic wave generating unit and an electromagnetic wave receiving unit corresponding to each other. The electromagnetic wave generating unit is electrically connected to the solar energy conversion unit to convert electrical energy into electromagnetic wave, and then transmit electromagnetic wave to the lamp module. The electromagnetic wave receiving unit receives and converts electromagnetic wave into electrical energy to power the light source electrically connected thereto.

The wireless solar lamp assembly in accordance with the present invention is mainly applicable to a shed body or other similar structures; more specifically, the solar module is suitable to be installed on the external surface of the shed body, and the lamp module is suitable to be installed on the internal surface of the shed body. In this way, the first magnetic positioning element and the second magnetic positioning element can be attracted by each other by magnetic force, so the lamp module and the solar module can be swiftly and fixed on the shed body; accordingly, the user can install and remove the lamp assembly in a short time.

Moreover, the solar module and the lamp module in accordance with the present invention can not only use magnetic attraction function for positioning, but also can further calibrate the relative position between the electromagnetic wave generating unit and the electromagnetic wave receiving unit inside the both modules for the purpose of successfully finishing electricity transmission via wireless electromagnetic wave to reduce energy loss. On the other hand, the effective transmission distance of the wireless electromagnetic wave transmission technology according to the present invention can be up to 20 cm. However, in order to make the application of the lamp assembly more comprehensive, it is proper to design the transmission distance to be 4 mm. That is to say, when the thickness of the isolation layer (it usually means the thickness of the shed cloth) is lower than 4 mm, the first magnetic positioning element and the second magnetic positioning element can have great magnetic attraction and positioning effect; in addition, the electromagnetic wave generating unit and the electromagnetic wave receiving unit can also have excellent electromagnetic transmission effect.

Preferably, the lamp holder further includes a combination mechanism for fixing the lamp holder on a shed holder of the shed body; the combination mechanism includes an adjustment element in a clamping groove of the lamp holder, and the adjustment element is used to adjust the size of the clamping groove to properly clamp the lamp holder on the shed holder.

Preferably, the solar module further includes a plurality of the first magnetic positioning elements, and the first magnetic positioning elements are arranged in a circle; the lamp module includes a plurality of the second magnetic positioning elements corresponding to the first magnetic positioning elements.

Preferably, the first magnetic positioning elements are in the same magnetic pole arrangement or different magnetic pole arrangement; in particular, the design of the different magnetic pole arrangement can further calibrate the magnetic attraction position between the solar module and the lamp module during installation in order to increase the electromagnetic transmission effect between the both modules.

Preferably, the wireless solar lamp assembly further includes a conversion circuit with rectification function disposed between the electromagnetic wave receiving unit and the light source.

Preferably, at least one of the solar module and the lamp module includes a storage unit capable of storing electrical energy. More specifically, when the solar module includes the storage unit, the storage unit is electrically connected to and intervened between the solar energy conversion unit and the electromagnetic wave generating unit so as to store electrical energy generated by the solar energy conversion unit and then properly power the electromagnetic wave generating unit. When the lamp module includes the storage unit, the storage unit is electrically connected to and intervened between the electromagnetic wave receiving unit and the light source so as to store electrical energy converted by the electromagnetic wave receiving unit and then properly power the light source. Further, the conversion circuit is disposed between the electromagnetic wave receiving unit and the storage unit. In addition, the lamp module further can set a rechargeable connector (like USB) practically when the storage unit is disposed at the lamp module, which provides the capability of electricity store to the lamp module and be applied to use in any weather environment.

Preferably, the wireless solar lamp module further includes a control unit, and the storage unit and the light source are controlled by the control unit. The control unit can be disposed in a substrate structure to provide various functions, such as remote control and additional charging sockets.

Preferably, the light source is disposed at one side of the lamp holder, and the light source is capped by a lamp cover connected to the lamp holder.

Preferably, the light source is a LED, and connected to a light guiding element.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a schematic view of an appearance of a wireless solar lamp assembly of a preferred embodiment in accordance with the present invention.

FIG. 2 is a schematic view of disassembling and assembling a wireless solar lamp assembly of a preferred embodiment in accordance with the present invention.

FIG. 3 is a schematic view of an application situation of a wireless solar lamp assembly of a preferred embodiment in accordance with the present invention.

FIG. 4 is a schematic view of another application situation of a wireless solar lamp assembly of a preferred embodiment in accordance with the present invention.

FIG. 5 is a schematic view of an internal circuit of a wireless solar lamp assembly of a preferred embodiment in accordance with the present invention.

FIG. 6 is a schematic view of an internal circuit of a wireless solar lamp assembly of another preferred embodiment in accordance with the present invention.

FIG. 7 is a schematic view of an internal circuit of a wireless solar lamp assembly of still another preferred embodiment in accordance with the present invention.

### DETAILED DESCRIPTION OF THE PREFERRED EMBODIMENTS

The technical content of the present invention will become apparent by the detailed description of the following embodiments and the illustration of related drawings as follows.

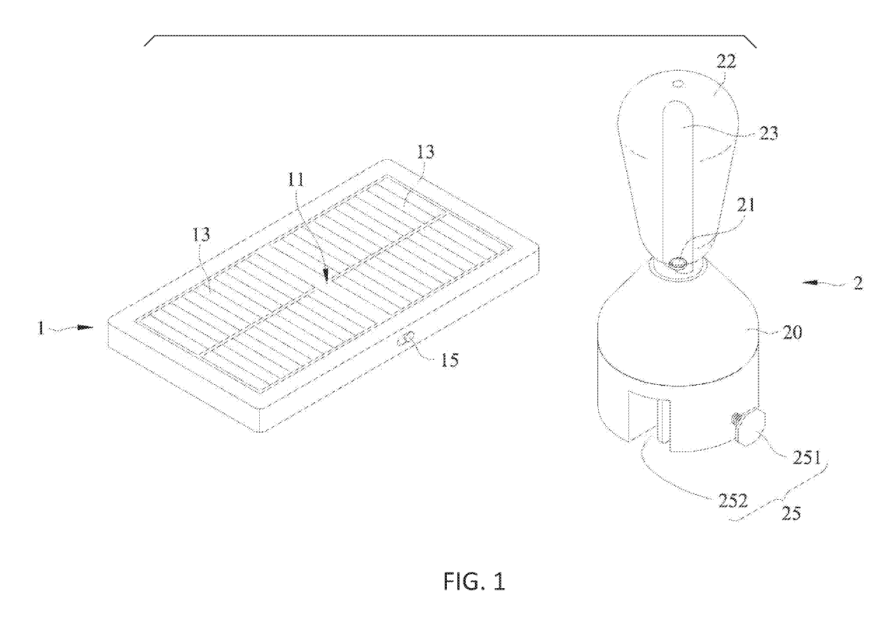

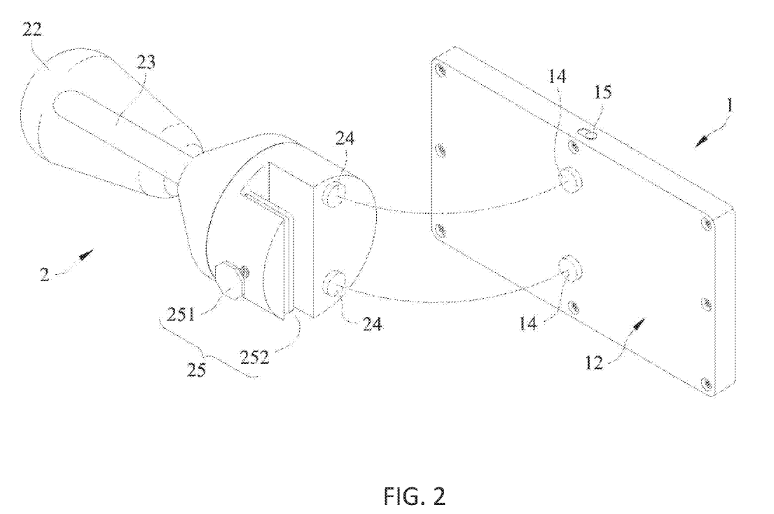

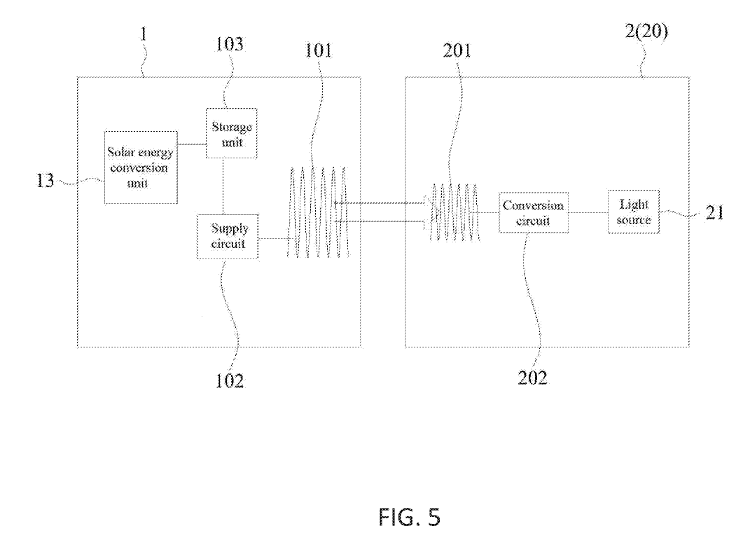

Please refer to FIG. 1, FIG. 2 and FIG. 5; the wireless solar lamp assembly mainly includes a solar module 1 and a lamp module 2.

The solar module 1 is a flat and rectangular object, and the top surface and the bottom surface thereof are respectively a light receiving surface 11 and an installation surface 12. The light receiving surface 11 includes an exposed solar energy conversion unit 13 for receiving and converting light into electrical energy; the installation surface 12 includes two first magnetic positioning elements 14 therein. The solar module 1 includes an electromagnetic wave generating unit 101, a supply circuit 102 and a storage unit 103 therein. The storage unit 103 is electrically connected to the solar energy conversion unit 13 so as to store electrical energy converted by the solar energy conversion unit 13, and then supply electrical energy to the electromagnetic wave generating unit 101 by electrically connecting to the electromagnetic wave generating unit 101 via the supply circuit 102. After receiving electrical energy, the electromagnetic wave generating unit 101 converts electrical energy into electromagnetic wave and then transmit which to a predetermined direction. Preferably, whether the supply circuit 102 functions or not can be controlled by a switch 15 connected thereto, and the switch 15 is exposed from one side of the solar module 1, so the user can directly operate the switch 15 in order to control the solar module 1 to supply power or not.

The lamp module 2 includes a lamp holder 20, a light source 21, a lamp cover 22 and a light guiding element 23. The light source 21 is disposed on top of the lamp holder 20; the lamp cover 22 caps the light source 21 and connects to the lamp holder 20; the light guiding element 23 is disposed inside the lamp cover 22 and connects to the light source 21. There are two hidden second magnetic positioning elements 24 inside the bottom of the lamp holder 20, which are corresponding to the first magnetic positioning elements 14. Thus, the lamp module 2 can be combined with the solar module 1 via the magnetic attraction between the first magnetic positioning elements 14 and the second magnetic positioning elements 24; then, the assembly thereof can be installed and fixed on a predetermined object by magnetic attraction or clamping. In addition, the lamp holder 20 includes an electromagnetic wave receiving unit 201 and a conversion circuit 202 disposed therein. The electromagnetic wave receiving unit 201 is disposed at the position corresponding to that of the electromagnetic wave generating unit 101, and can receive and convert electromagnetic wave generated by the electromagnetic wave generating unit 101 into electrical energy. The conversion circuit 202 is disposed between the electromagnetic wave receiving unit 201 and the light source 21, and can rectify electrical energy into current suitable for the light source 21 so as to power the light source 21.

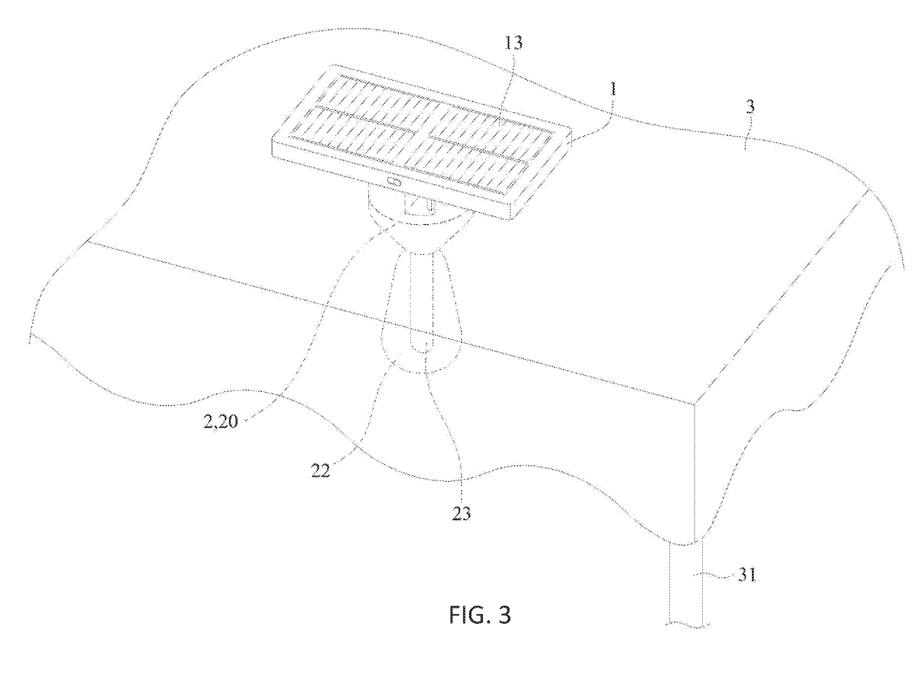

In general, the wireless solar lamp assembly can be used together with a shed body 3; the user only needs to install and fix the solar module 1 and the lamp module 2 on the shed body 3 without additional wiring and special method, which is very convenient in use. As shown in FIG. 3, the user just needs to respectively fix the solar module 1 and the lamp module 2 on the internal surface and the external surface of the shed body 3 by magnetic attraction (the two modules are usually fixed on the shed cloth by magnetic attraction; however, these modules can also be fixed on other proper positions if the structure of the shed body 3 is different from FIG. 3; however, the distance between these modules magnetically attracted by each other had better to be within 4 mm in order to make sure the magnetic attraction force and the electromagnetic transmission efficiency are sufficient). When radiated by sunshine, the solar module 1 can absorb and convert light into electrical energy so as to store electrical energy. After the user turns on the switch, the electromagnetic wave generating unit 101 can start to transmit electromagnetic wave for power transmission. Afterward, the electromagnetic wave receiving unit 201 of the lamp module 2 can immediately receive the electromagnetic wave, and then convert and rectify which into proper current for the light source 21; finally, the light source 21 can be powered to emit light.

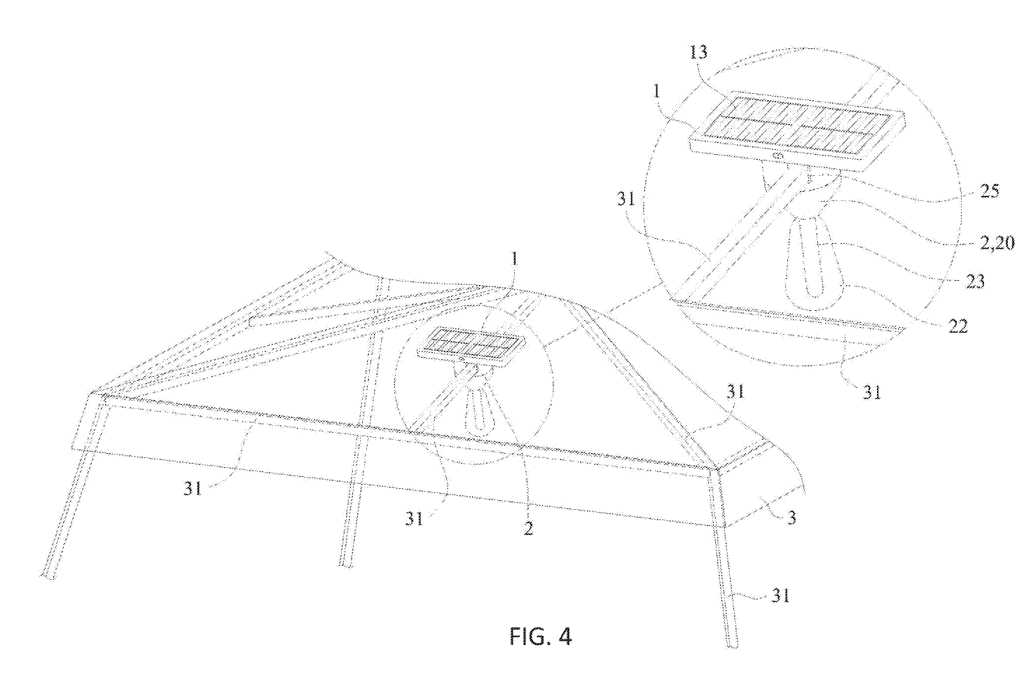

Please further refer to FIG. 1, FIG. 2 and FIG. 4; according to the present invention, the bottom of the lamp holder 20 can be further provided with a combination mechanism 25, which can be used to fix the lamp holder 20 on the shed holder 31 of the shed body 3; in this way, the lamp assembly can be more stably fixed on the shed body 3, and is applicable to various shed bodies 3 with different structures (as shown in FIG. 4, the top of the shed body is quite oblique). In the embodiment, the combination mechanism 25 includes a clamping groove 252 and an adjustment element 251. The adjustment element 251 can adjust the size of the clamping groove 252, whereby the clamping groove 252 can be applicable to the shed holders 31 with different widths. When installing the lamp assembly, the user just needs to clamp the lamp module 2 on the shed holder 31 from the internal surface of the shed body 3, and then fix the solar module 1 at the position on the external surface of the shed body 3 by magnetic attraction; therefore, the user can easily finish the installation of the lamp assembly.

In another preferred embodiment, the quantity of the first magnetic positioning elements 14 can be increased or decreased according to actual requirements. Besides, the first magnetic positioning elements 14 can be arranged in a circle or other forms, and can also be in the same magnetic pole arrangement or different magnetic pole arrangement; further, the second magnetic positioning elements 24 are corresponding to the first magnetic positioning elements 14. In the embodiment, for the purpose of making the electromagnetic wave generating unit 101 and the electromagnetic wave receiving unit 201 be at the best positions when fixing the solar module 1 on the lamp holder 20, the two first magnetic positioning elements 14 of the embodiment are arranged in different magnetic pole arrangement (the second magnetic positioning elements 24 are in the magnetic pole arrangement reverse to which). In this way, when assembling the lamp holder 20 and the solar module 1, the magnetic attraction combination can only be achieved by one direction (if the lamp holder 20 is rotated by 180°, the lamp holder 20 and the solar module 1 will repel each other). Therefore, it is necessary to make sure that the electromagnetic wave generating unit 101 and the electromagnetic wave receiving unit 201 respectively inside the both elements are arranged in the positions corresponding to each other so as to reduce energy waste during the transmission of electromagnetic wave.

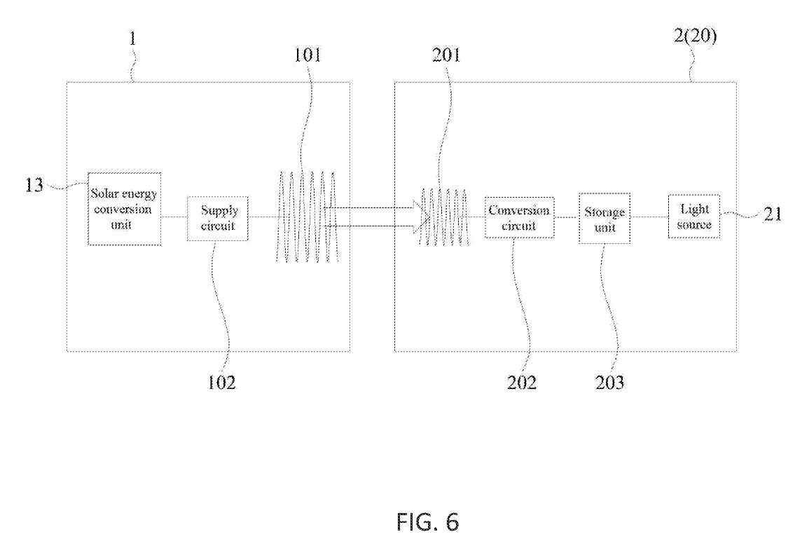

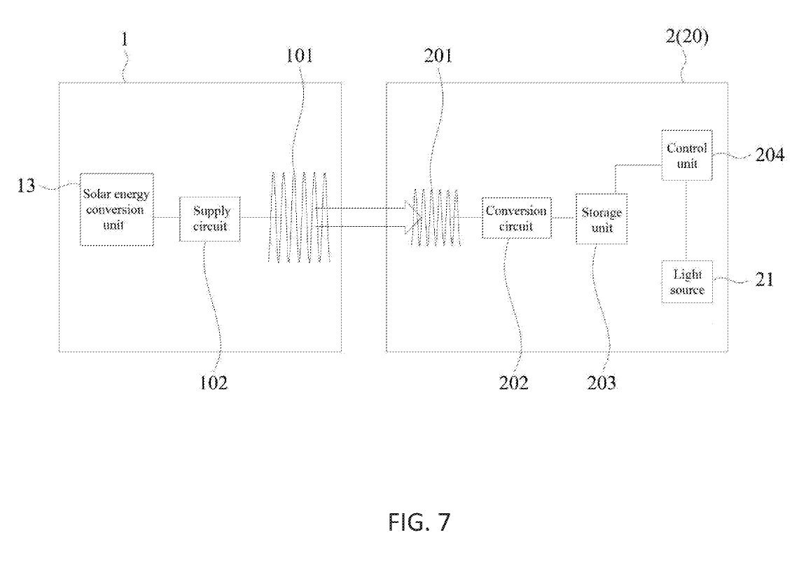

Please refer to FIG. 6, which is a schematic view of an internal circuit of a wireless solar lamp assembly of another preferred embodiment in accordance with the present invention; in the embodiment, the storage unit is disposed in the lamp holder 20 of the lamp module 2. As shown in FIG. 6, the solar module 1 is orderly electrically connected to a solar energy conversion unit 13, a supply circuit 102 and an electromagnetic wave generating unit 101. The lamp holder 20 of the lamp module 2 is orderly electrically connected to an electromagnetic wave receiving unit 201, a conversion circuit 202, a storage unit 203 and a light source 21. By means of the above structure, solar energy can be converted, wireless transmitted and then stored when being in use so as to directly supply power to the light source 21 or for other applications. As shown in FIG. 7, the lamp holder 20 can further include a control unit 204, and the control unit 204 can be intervened between the storage unit 203 and the light source 21. In implementation, the control unit 204 can be disposed in a substrate structure, which can further provide remote control, additional charging sockets or other various functions by programming or web, etc.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A wireless solar lamp assembly, applicable to a shed body comprising:
a solar module, applicable to be installed on an external surface of the shed body, and comprising a light receiving surface and an installation surface, wherein the light receiving surface comprises a solar energy conversion unit capable of receiving and converting a light into an electrical energy, and the installation surface comprises at least one first magnetic positioning element; and
a lamp module, applicable to be installed on an internal surface of the shed body, comprising a lamp holder with a light source, wherein a bottom of the lamp holder comprises at least one second magnetic positioning element corresponding to the first magnetic positioning element, and the second magnetic positioning is used to magnetically connect to the first magnetic positioning element, whereby the lamp module and the solar module are able to be respectively installed on both sides of the shed body;
wherein the solar module and the lamp module respectively include an electromagnetic wave generating unit and an electromagnetic wave receiving unit corresponding to each other; the electromagnetic wave generating unit is electrically connected to the solar energy conversion unit to convert the electrical energy into an electromagnetic wave, and then transmit the electromagnetic wave to the lamp module; the electromagnetic wave receiving unit receives and converts the electromagnetic wave into the electrical energy to power the light source electrically connected thereto.

2. The wireless solar lamp assembly of claim 1, wherein the lamp holder further comprises a combination mechanism for fixing the lamp holder on a shed holder of the shed body.

3. The wireless solar lamp assembly of claim 2, wherein the combination mechanism comprises an adjustment element in a clamping groove of the lamp holder, and the adjustment element is used to adjust a size of the clamping groove to clamp the lamp holder on the shed holder.

4. The wireless solar lamp assembly of claim 1, wherein the solar module comprises a plurality of the first magnetic positioning elements, and the first magnetic positioning elements are arranged in a circle; the lamp module comprises a plurality of the second magnetic positioning elements corresponding to the first magnetic positioning elements.

5. The wireless solar lamp assembly of claim 1, wherein the first magnetic positioning elements are in the same magnetic pole arrangement or a different magnetic pole arrangement.

6. The wireless solar lamp assembly of claim 1, wherein the solar module further comprises a storage unit, and the storage unit is electrically connected to and intervened between the solar energy conversion unit and the electromagnetic wave generating unit so as to store the electrical energy generated by the solar energy conversion unit to power the electromagnetic wave generating unit.

7. The wireless solar lamp assembly of claim 6, further comprising a conversion circuit with rectification function disposed between the electromagnetic wave receiving unit and the light source.

8. The wireless solar lamp assembly of claim 1, wherein the lamp module further comprises a storage unit, and the storage unit is electrically connected to and intervened between the electromagnetic wave receiving unit and the light source so as to store the electrical energy converted by the electromagnetic wave receiving unit to power the light source.

9. The wireless solar lamp assembly of claim 8, further comprising a conversion circuit with rectification function disposed between the electromagnetic wave receiving unit and the storage unit.

10. The wireless solar lamp assembly of claim 9, wherein the lamp module further comprises a control unit, and the storage unit and the light source are controlled by the control unit.

11. The wireless solar lamp assembly of claim 10, wherein the light source is disposed at one side of the lamp holder, and the light source is capped by a lamp cover connected to the lamp holder.

12. The wireless solar lamp assembly of claim 11, wherein the light source is a LED, and connected to a light guiding element.

13. The wireless solar lamp assembly of claim 7, wherein the light source is disposed at one side of the lamp holder, and the light source is capped by a lamp cover connected to the lamp holder.

14. The wireless solar lamp assembly of claim 13, wherein the light source is a LED, and connected to a light guiding element.

15. A wireless solar lamp assembly, comprising:
a solar module, comprising a light receiving surface and an installation surface, wherein the light receiving surface comprises a solar energy conversion unit capable of receiving and converting a light into an electrical energy, and the installation surface comprises at least one first magnetic positioning element; and
a lamp module, comprising a lamp holder with a light source, wherein a bottom of the lamp holder comprises at least one second magnetic positioning element corresponding to the first magnetic positioning element, and the second magnetic positioning element is used to magnetically connect to the first magnetic positioning element, whereby the lamp module and the solar module are able to be respectively installed on both sides of a predetermined object;
wherein the solar module and the lamp module are respectively include an electromagnetic wave generating unit and an electromagnetic wave receiving unit corresponding to each other; the electromagnetic wave generating unit is electrically connected to the solar energy conversion unit to convert the electrical energy into an electromagnetic wave, and then transmit the electromagnetic wave to the lamp module; the electromagnetic wave receiving unit receives and converts the electromagnetic wave into the electrical energy to power the light source electrically connected thereto.

16. The wireless solar lamp assembly of claim 15, wherein the lamp holder further comprises a clamping groove, and an adjustment element used to adjust a size of the clamping groove.

17. The wireless solar lamp assembly of claim 15, wherein the solar module comprises a plurality of the first magnetic positioning elements, and the first magnetic positioning elements are arranged in a circle; the lamp module comprises a plurality of the second magnetic positioning elements corresponding to the first magnetic positioning elements.

18. The wireless solar lamp assembly of claim 17, wherein the first magnetic positioning elements are in the same magnetic pole arrangement or a different magnetic pole arrangement.

19. The wireless solar lamp assembly of claim 16, wherein at least one of the solar module and the lamp module comprises a storage unit capable of storing the electrical energy.

20. The wireless solar lamp assembly of claim 18, wherein at least one of the solar module and the lamp module comprises a storage unit capable of storing the electrical energy.
